(19) United States
(12) Patent Application Publication
(10) Pub. No.: US 2008/0177761 A1
(43) Pub. Date: Jul. 24, 2008

(54) Dynamically optimized storage system for online user activities

(76) Inventors: Andrew An Feng, Cupertino, CA (US); Nilesh Ramniklal Gohel, Fremont, CA (US)

Correspondence Address: STATTLER - SUH PC, 60 SOUTH MARKET STREET, SUITE 480, SAN JOSE, CA, 95113, US

(21) Appl. No.: 11/655,675

(22) Filed: Jan. 19, 2007

(51) Int. Cl. G06F 17/30

(52) U.S. Cl. 707/100; 707/E17.002

(57) ABSTRACT

A system and method to optimize storage of activities performed by a user over a network are further described, wherein activity information related to an activity performed by a user over a network is received. The activity information is further processed based on associated schema information to extract primary property information related to the user and containing an activity identification parameter related to the activity and secondary property information related to additional aspects of the activity. Finally, the primary property information and the secondary property information are transmitted to respective storage modules for subsequent storage. A method to retrieve optimized activity information is further described, wherein a request to retrieve user activity information is received from advertising servers. Schema information related to the user is further retrieved from a schema module. The user-specific primary property information and the secondary property information are further retrieved from the respective storage modules. The primary property information and the secondary property information are further processed and transmitted to the advertising servers in response to the received request.

### TECHNICAL FIELD

The present invention relates generally to the field of network-based communications and, more particularly, to a system and method to optimize storage of activities performed by users over a network, such as the Internet.

### BACKGROUND OF THE INVENTION

The explosive growth of the Internet as a publication and interactive communication platform has created an electronic environment that is changing the way business is transacted. As the Internet becomes increasingly accessible around the world, users need efficient tools to navigate the Internet and to find content available on various websites.

Internet portals provide users an entrance and guide into the vast resources of the Internet. Typically, an Internet portal provides a range of search, email, news, shopping, chat, maps, finance, entertainment, and other content and services. Many online services either automatically remember the users' recent activities or enable users to save their activities for subsequent use. The recent activities and/or saved activities will then be included in the web page accessed by the user. The portal could then make various personalized recommendations, advertisements, and/or personalization based on such user activities.

Several attempts have been made to create storage systems for recent/saved activities performed by users over a network. These storage systems try to solve the problem of an ever increasing amount of data needed to be stored by either storing activities on users' computers or limit the amount of activities being stored. However, such solutions lead into limited opportunities for online service providers or portals to produce effective targeted advertisements and/or personalization.

Thus, what is needed is a system for storing user activities that is dynamically optimized to achieve best performance/cost ratio.

### SUMMARY OF THE INVENTION

A system and method to optimize storage of activities performed by a user over a network are described. In some embodiments, activity information related to an activity performed by a user over a network is received. The activity information is further processed based on associated schema information to extract primary property information related to the user and containing an activity identification parameter related to the activity and secondary property information related to additional aspects of the activity. Finally, the primary property information and the secondary property information are transmitted to respective storage modules for subsequent storage. If the user activity is new and respective associated information has not been previously stored, or if the secondary property information needs updating, then the primary property information and the secondary property information are stored within the respective storage modules. Alternatively, if the secondary property information has already been stored from a previous user activity and is unchanged, then the secondary property information is further discarded and a count is updated to show the amount of times the secondary information has been available for storage.

In alternate embodiments, a method to retrieve optimized activity information is described. A request to retrieve user activity information is received from advertising servers. Schema information related to the user is further retrieved from a schema module. The user-specific primary property information and the secondary property information are further retrieved from the respective storage modules. The primary property information and the secondary property information are further processed and transmitted to the advertising servers in response to the received request.

Other features and advantages of the present invention will be apparent from the accompanying drawings, and from the detailed description, which follows below.

### BRIEF DESCRIPTION OF THE DRAWINGS

The present invention is illustrated by way of example and not intended to be limited by the figures of the accompanying drawings in which like references indicate similar elements and in which:

FIG. 1 is a flow diagram illustrating a processing sequence to optimize storage of activities performed by a user over a network, according to one embodiment of the invention;

FIG. 2 is a block diagram illustrating an exemplary network-based entity containing a system to optimize storage of activities performed by a user over a network, according to one embodiment of the invention;

FIG. 3 is a block diagram illustrating a system to optimize storage of activities performed by a user over a network, according to one embodiment of the invention;

FIG. 4 is a block diagram illustrating a schema module within the system to optimize storage of activities, which at least partially implements and supports the network-based entity, according to one embodiment of the invention;

FIG. 5 is an interaction diagram illustrating a method to optimize storage of activities performed by a user over a network, according to one embodiment of the invention;

FIG. 6 is an interaction diagram illustrating a method to retrieve optimized activity information, according to one embodiment of the invention;

FIG. 7 is a flow diagram illustrating a method to optimize storage of activities performed by a user over a network, according to one embodiment of the invention;

FIG. 8 is a flow diagram illustrating a method to retrieve optimized activity information, according to one embodiment of the invention;

FIG. 9 is a diagrammatic representation of a machine in the exemplary form of a computer system within which a set of instructions may be executed.

### DETAILED DESCRIPTION

Activities or events initiated and input by a user or an agent of the user over a network, such as, for example, search queries, web page views, and/or advertisement clicks, are generally received through a network and stored into one or more data storage modules, such as, for example, databases or datastores.

In some embodiments described below, prior to storage, each user activity is processed to aggregate multiple similar activities into a single entry, to detect duplicated data among activities and to dynamically adjust them into a normalized format, and to discard unwanted user activities in order to reclaim resources. Primary information related to the user and basic activity information is further stored within an activity storage module, and secondary information related to the type of activity performed by the user and other metadata related to the activity is further stored within a catalog storage module.

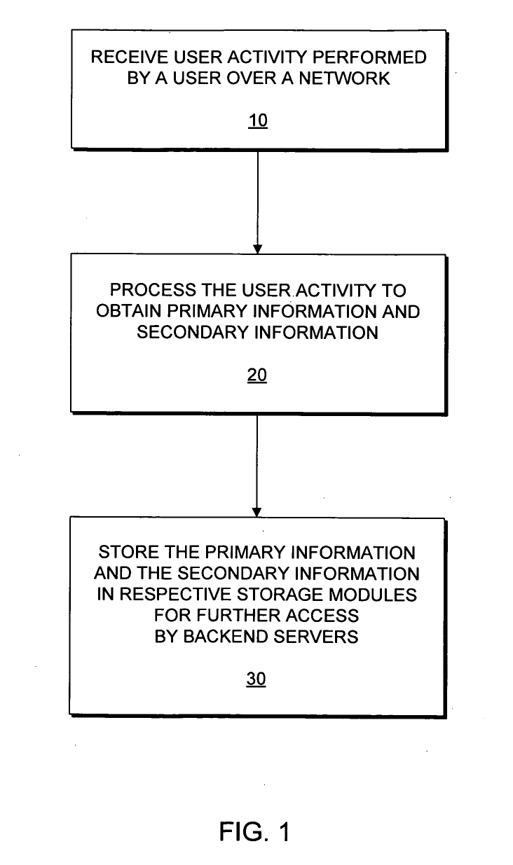

FIG. 1 is a flow diagram illustrating a processing sequence to optimize storage of activities performed by a user over a network, according to one embodiment of the invention. As shown in FIG. 1, at processing block 10, the sequence starts with receipt of an activity or event performed by a user or an agent of the user over a network. In one embodiment, an activity or event is a type of action initiated by a user, typically through a conventional mouse click command. Activities include, for example, search queries, web page views, sponsored listing clicks, and advertisement views. However, activities, as used herein, may include any type of online navigational interaction or search-related actions or events.

Generally, a page view activity or event occurs when the user views a web page. In one example, a user may enter a music-related web page within an Internet portal by clicking on a link for the music category page. Thus, a page view event is classified as the user's view of the music category page.

A search query activity or event occurs when a user submits one or more search terms within a search query to a web-based search engine. For example, a user may submit the query “Sony camcorder”, and a corresponding search query event containing the query keywords “Sony” and “camcorder” is recorded. In response to a user query, a web-based search engine returns a plurality of links to web pages relevant to the corresponding search query keywords.

An advertisement view activity or event occurs when the user views a web page for an advertisement. For example, an Internet portal may display banner advertisements on the home page of the portal. If the user clicks on the banner advertisement, the portal redirects the user to the link for the corresponding advertiser. The display of a web page, in response to the conventional mouse click command, constitutes an advertisement click event. A user may then generate multiple page view events by visiting multiple web pages at the advertiser's web site.

An advertisement click activity or event occurs when a user clicks on an advertisement. For example, a web page may display a banner advertisement. An advertisement click activity or event occurs when the user clicks on the banner advertisement.

A sponsored listing advertisement refers to advertisements that are displayed in response to a user's search criteria. A sponsored listing click activity or event occurs when a user clicks on a sponsored listing advertisement displayed for the user.

Next, referring back to FIG. 1, at processing block 20, the received user activity is processed to extract primary information related to the user and further containing basic activity information, and secondary information related to the type of activity performed by the user. In one embodiment, user identification information is retrieved, and associated activity information is further extracted from the received user activity, as described in further detail below.

Finally, the sequence continues at processing block 30 with transmittal of the primary information and the secondary information for subsequent storage within respective storage modules, as described in further detail below.

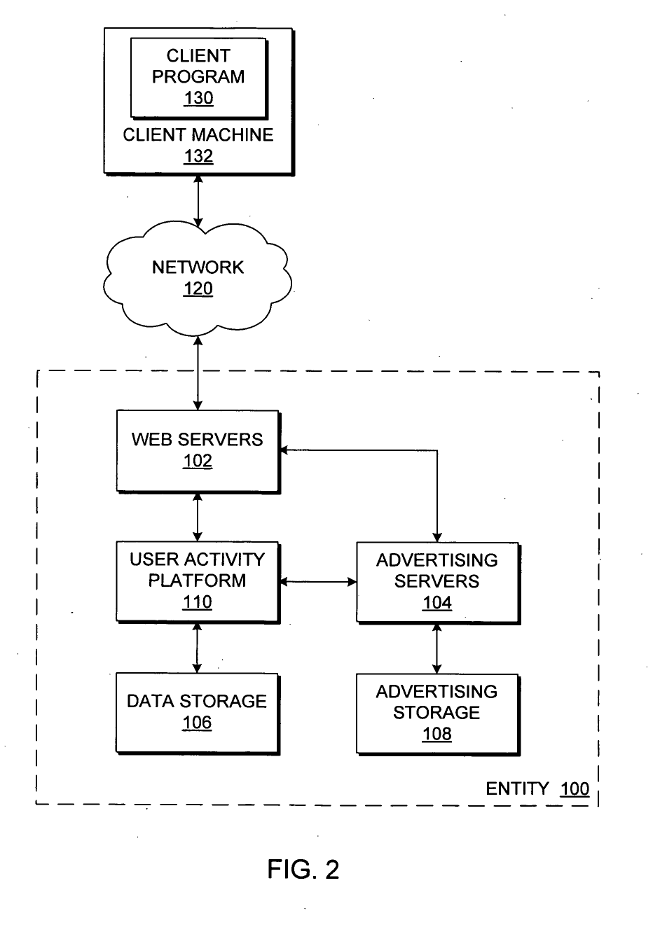

FIG. 2 is a block diagram illustrating an exemplary network-based entity 100 containing a system to optimize storage of activities performed by a user over a network. While an exemplary embodiment of the present invention is described within the context of an entity 100 enabling optimization of storage operations, it will be appreciated by those skilled in the art that the invention will find application in many different types of computer-based, and network-based, entities, such as, for example, commerce entities, content provider entities, or other known entities having a presence on the network.

In one embodiment, the entity 100, such as, for example, an Internet portal, includes one or more front-end web servers 102, which may, for example, deliver web pages to multiple users, (e.g., markup language documents), handle search requests to the entity 100, provide automated communications to/from users of the entity 100, deliver images to be displayed within the web pages, deliver content information to the users, and other front-end servers, which provide an intelligent interface to the back-end of the entity 100.

The entity 100 further includes one or more back-end servers, for example, one or more advertising servers 104 and a user activity platform 110, each of which maintaining and facilitating access to one or more respective data storage modules, such as, for example, a data storage module 106 and an advertising storage module 108. Alternatively, the entity 100 may also include other known back-end servers (not shown), such as, for example, processing servers and/or database servers.

In one embodiment, the user activity platform 110 is coupled to the data storage module 106 and is configured to optimize storage of activities performed by a user within the network-based entity 100, as described in further detail below. In one embodiment, the advertising servers 104 are coupled to the respective advertising storage module 108 and are configured to select and transmit content, such as, for example, advertisements, sponsored links, integrated links, and other types of advertising content, to users via the network 120, as described in further detail below.

In one embodiment, a client program 130, such as a browser (e.g., the Internet Explorer browser distributed by Microsoft Corporation of Redmond, Wash.), that executes on a client machine 132 coupled to the user or acting as an agent of the user, may access the network-based entity 100 via a network 120, such as, for example, the Internet. Other examples of networks that a client may utilize to access the entity 100 includes a wide area network (WAN), a local area network (LAN), a wireless network (e.g., a cellular network), the Plain Old Telephone Service (POTS) network, or other known networks.

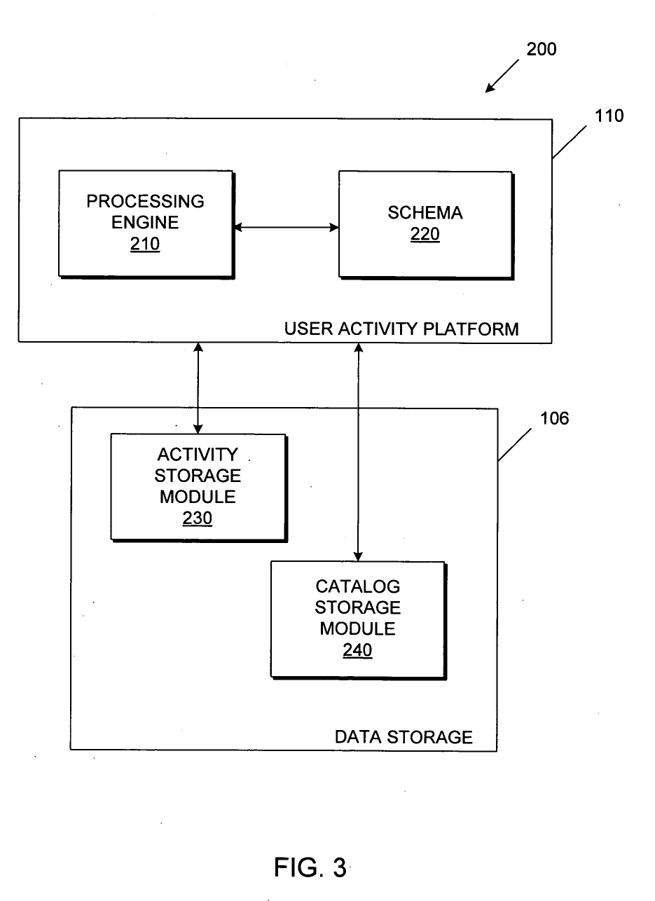

FIG. 3 is a block diagram illustrating a system 200 to optimize storage of activities performed by a user over a network, according to one embodiment of the invention. As shown in FIG. 3, the system 200 includes the user activity platform 110 coupled to the data storage module 106.

In one embodiment, the data storage module 106 further includes an activity storage module 230 and a catalog storage module 240. The activity storage module 230 and the catalog storage module 240 may each be a database or collection of databases, which may be implemented as a relational database, and may include a number of tables having entries, or records, that are linked by indices and keys. Alternatively, the modules 230 and 240 may be implemented as a collection of objects in an object-oriented database, as a distributed database, or any other such databases. The activity storage module 230 stores primary information related to the user and basic information associated with the received activities. The catalog storage module 240 stores secondary information related to the processed user activities, as described in further detail below.

In one embodiment, the user activity platform 110 further includes a processing engine 210 and a schema module 220 coupled to the processing engine 210. The processing engine 210 is a hardware and/or software module configured to perform parsing, processing, and classification operations of user activities received over the network 120, as described in further detail below.

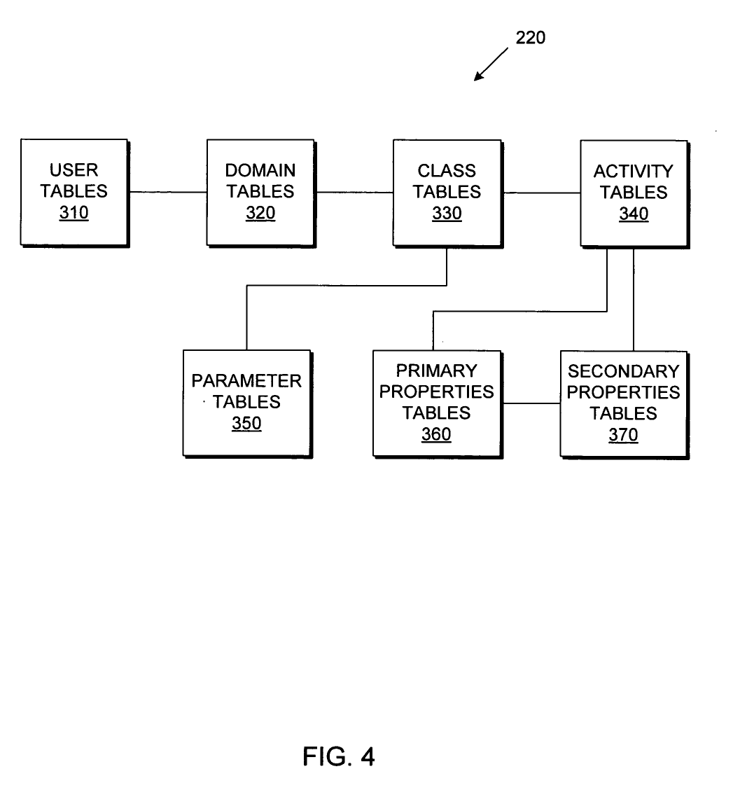

The schema module 220 may be a database or collection of databases, which may be implemented as a relational database, and may include a number of tables having entries, or records, that are linked by indices and keys. Alternatively, the schema module 220 may be implemented as a collection of objects in an object-oriented database, as a distributed database, or any other such databases. The schema module 220 stores schema information, which is, for example, metadata information related to each user activity received at the entity 100, as described in detail below in connection with FIG. 4.

FIG. 4 is a block diagram illustrating a schema module 220 within the system 200 to optimize storage of activities, which at least partially implements and supports the network-based entity 100, according to one embodiment of the invention. As shown in FIG. 4, the schema module 220 includes multiple storage facilities, such as, for example, multiple databases or, in the alternative, tables within a database, of which facilities specifically provided to enable an exemplary embodiment of the invention, namely user tables 310, domain tables 320, class tables 330, activity tables 340, parameter tables 350, primary properties tables 360, and secondary properties tables 370, are shown.

In one embodiment, the user tables 310 contain a record for each user of the entity 100, such as, for example, a user profile containing user data which may be linked to multiple items stored in the other databases 320 through 370 within the data storage module 106, such as, for example, user identification information, user account information, and other known data related to each user. The user identification information may further include demographic data about the User, geographic data detailing user access locations, behavioral data related to the user, such behavioral data being generated by a behavioral targeting system, which analyzes user events or activities in connection with the entity 100 and identifies interests of the user based on the analyzed activities, and other identification information related to each specific user, such as cookies related to the client browser 130 connected to the user.

In one embodiment, each activity stored within the activity tables 340 is associated with a user and is further classified into domains, which characterize a common theme among related activities, such as, for example, user activities related to search marketing, and/or user activities related to shopping at a specific web site. The domains are further stored within the domains tables 320.

In one embodiment, each domain further includes multiple classes, which further categorize the received user activities and are stored within the class tables 330. In one example, the shopping domain may contain user activities divided into a “viewed products” class, a “saved products” class, and a “recent searches” class.

In one embodiment, the schema module 220 provides a data model to define each activity class within the class tables 330, based on a set of activity parameters stored within the parameter tables 350, such as, for example, an aggregation style parameter, which is provided to avoid individual storage of user activities and aggregation of similar activities, and an expiration policy parameter, which defines when should an activity be discarded, and regulates the updating process of the databases.

In one embodiment, the schema module 220 may also provide a set of primary properties associated with the user activity and stored within the primary properties tables 360, and a set of secondary properties associated with the user activity and stored within the secondary properties tables 370. The primary properties contain user identification information corresponding to the user that performed the activity and basic activity information, such as, for example, an activity identification parameter. For example, considering the case of a user performing product viewing activities on a web site, the primary properties may include a user ID and a product ID that the user viewed. The secondary properties include additional activity information, such as, for example, the name of the product, the URL of the site where the product is displayed, the image of the product, and/or the brand of the product, which could be derived from the primary properties (i.e. the product ID) through indices and keys, which connect data from the primary properties tables 360 with data from the secondary properties tables 370.

In one embodiment, instead of storing all properties across users, the primary property information may be stored within the activity storage module 230 and the secondary property information may be stored within the catalog storage module 240 only once, thus, reducing the resources required to handle user activities in response of requests from advertising servers 104, for example, as described in further detail below.

It is to be understood that the schema module 220 and the components within the data storage module 106 may include any of a number of additional databases or tables, which may also be shown to be linked to the user tables 310, the domain tables 320, the class tables 330, the activity tables 340, the parameter tables 350, the primary properties tables 360, and the secondary properties tables 370.

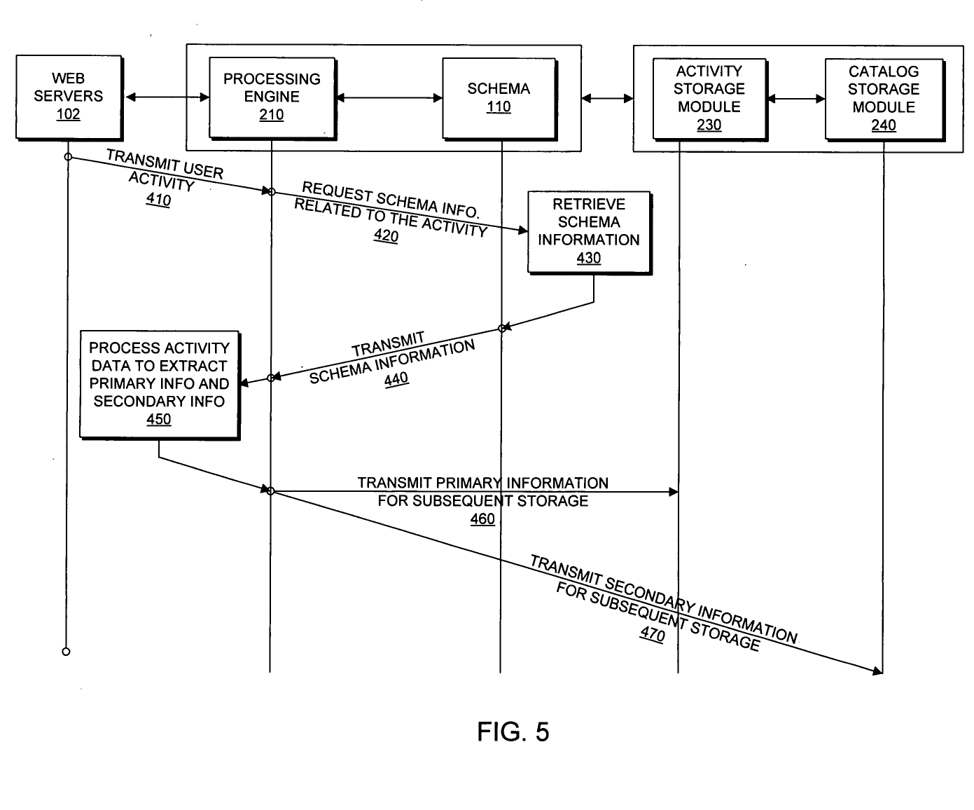

FIG. 5 is an interaction diagram illustrating a method to optimize storage of activities performed by a user over a network, according to one embodiment of the invention. As shown in FIG. 5, the method starts at processing block 410, where the web servers 102 transmit a user activity to the user activity platform 110, specifically to the processing engine 210 within the platform 110. In one embodiment, the web servers 102 within the entity 100 receive an activity performed by the user over the network 120 and transmit the user activity information to the processing engine 210.

At processing block 420, the processing engine 210 requests schema information related to the received user activity and stored within the schema module 220. In one embodiment, the processing engine 210 receives the activity performed by the user and the user identification information and accesses the schema module 220 to request a data model associated with the user activity.

At processing block 430, the schema module 220 retrieves schema information related to the received user activity from the respective tables 310 through 370. In one embodiment, the schema module 220 accesses the respective user tables 310, the domain tables 320, the class tables 330, the activity tables 340, the parameter tables 350, the primary properties tables 360, and the secondary properties tables 370 to retrieve general information associated with the activity, such as, for example, domain information, activity class information, additional parameter information, primary property information and secondary property information.

At processing block 440, the schema module 220 transmits the retrieved schema information to the processing engine 210. At processing block 450, the processing engine 210 processes the received user activity based on the schema information to extract primary information and secondary information associated with the specific user activity. In one embodiment, the processing engine 210 parses the user activity information and processes the parsed data based on the received schema information to extract primary property information, such as, for example, a user ID and a product ID, and secondary property information, such as, for example, the product name, brand, image, URL of the web site, etc.

At processing block 460, the processing engine 210 transmits the primary property information to the activity storage module 230 for subsequent storage in respective databases within the module 230. Finally, at processing block 470, the processing engine 210 transmits the secondary property information to the catalog storage module 240 for subsequent storage in respective databases within the module 240.

In one embodiment, if the user activity is new and respective associated information has not been previously stored, the primary property information and the secondary property information are stored within the respective storage modules 230 and 240. In an alternate embodiment, if the catalog storage module 240 already stores the secondary property information from a previous user activity, then the secondary property information is further discarded and a count is updated to show the amount of times the secondary information has been available for storage. In another alternate embodiment, if there is a change in the secondary property information, the change will be picked up the next time the user activity information is captured by the system 200 where it can be updated in the catalog storage module 240.

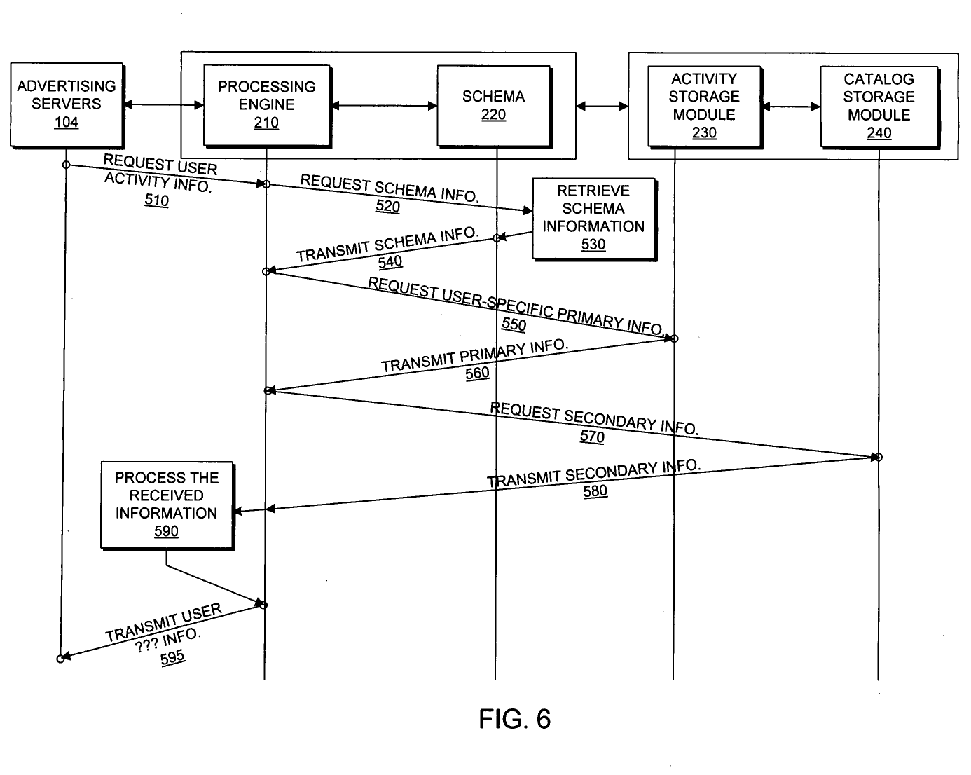

FIG. 6 is an interaction diagram illustrating a method to retrieve optimized activity information, according to one embodiment of the invention. As shown in FIG. 6, the method starts at processing block 510, where the advertising servers 104 transmit a request to the user activity platform 110, specifically to the processing engine 210 within the platform 110, to retrieve user activity information related to a user. In one embodiment, the advertising servers 104 within the entity 100 transmit the request for user activity information to the processing engine 210 based on user identification information received at the advertising servers 104.

At processing block 520, the processing engine 210 requests schema information related to the user and stored within the schema module 220. In one embodiment, the processing engine 210 receives the request from the advertising servers 104 and accesses the schema module 220 to request a data model associated with the user activity information.

At processing block 530, the schema module 220 retrieves schema information related to the received user activity information from the respective tables 310 through 370. In one embodiment, the schema module 220 accesses the respective user tables 310, the domain tables 320, the class tables 330, the activity tables 340, the parameter tables 350, the primary properties tables 360, and the secondary properties tables 370 to retrieve general information associated with the user activity, such as, for example, domain information, activity class information, additional parameter information, primary property information and secondary property information.

At processing block 540, the schema module 220 transmits the retrieved schema information to the processing engine 210. At processing block 550, the processing engine 210 requests user-specific primary information from the activity storage module 230. In one embodiment, the processing engine 210 accesses the activity storage module 230 within the data storage module 106 to retrieve primary property information stored within the activity storage module 230.

At processing block 560, the activity storage module 230 transmits the retrieved primary property information to the processing engine 210. At processing block 570, the processing engine 210 requests secondary information from the catalog storage module 240. In one embodiment, the processing engine 210 accesses the catalog storage module 240 within the data storage module 106 to retrieve secondary property information stored within the catalog storage module 240.

At processing block 580, the catalog storage module 240 transmits the retrieved secondary property information to the processing engine 210. At processing block 590, the processing engine 210 processes the received primary information and secondary information associated with the user activity and further transmits, at processing block 595, the primary property information and the secondary property information to the advertising servers 104.

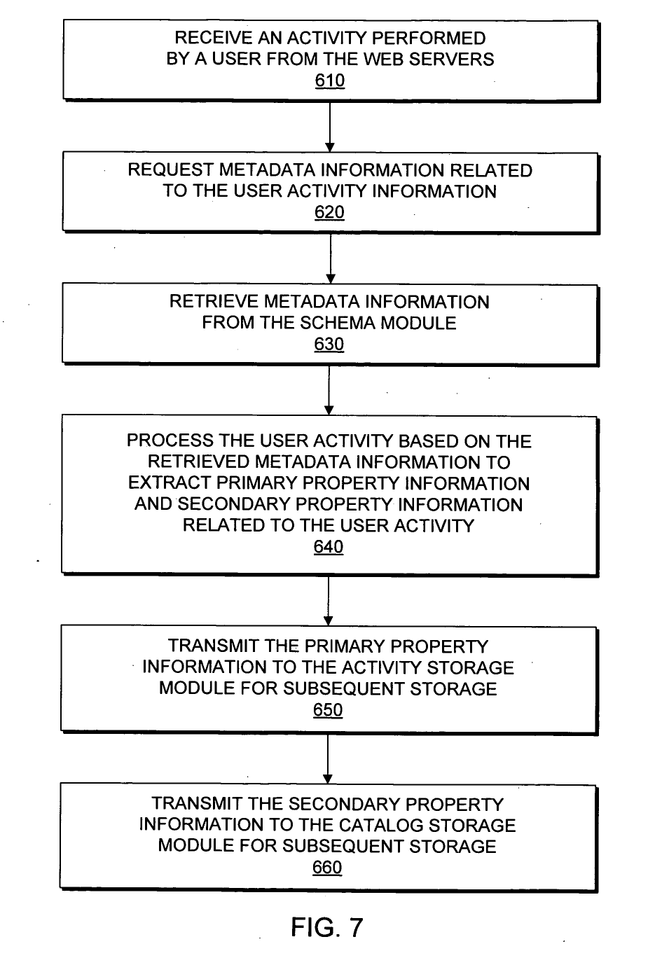

FIG. 7 is a flow diagram illustrating a method to optimize storage of activities performed by a user over a network, according to one embodiment of the invention. As shown in FIG. 7, at processing block 610, user activity information is received from web servers 102 within the entity 100.

At processing block 620, a request for schema information related to the user activity information is transmitted to a schema module 220. At processing block 630, schema information is retrieved from the schema module 220.

At processing block 640, the user activity information is processed based on the retrieved schema information to extract the primary property information and the secondary property information related to the user activity.

At processing block 650, the primary property information is further transmitted to the activity storage module 230 for subsequent storage. Finally, at processing block 660, the secondary property information is further transmitted to the catalog storage module 240 for subsequent storage.

In one embodiment, if the user activity is new and respective associated information has not been previously stored, the primary property information and the secondary property information are stored within the respective storage modules 230 and 240. In an alternate embodiment, if the catalog storage module 240 already stores the secondary property information from a previous user activity, then the secondary property information is further discarded and a count is updated to show the amount of times the secondary information has been available for storage. In another alternate embodiment, if there is a change in the secondary property information, the change will be picked up the next time the user activity information is captured by the system 200 where it can be updated in the catalog storage module 240.

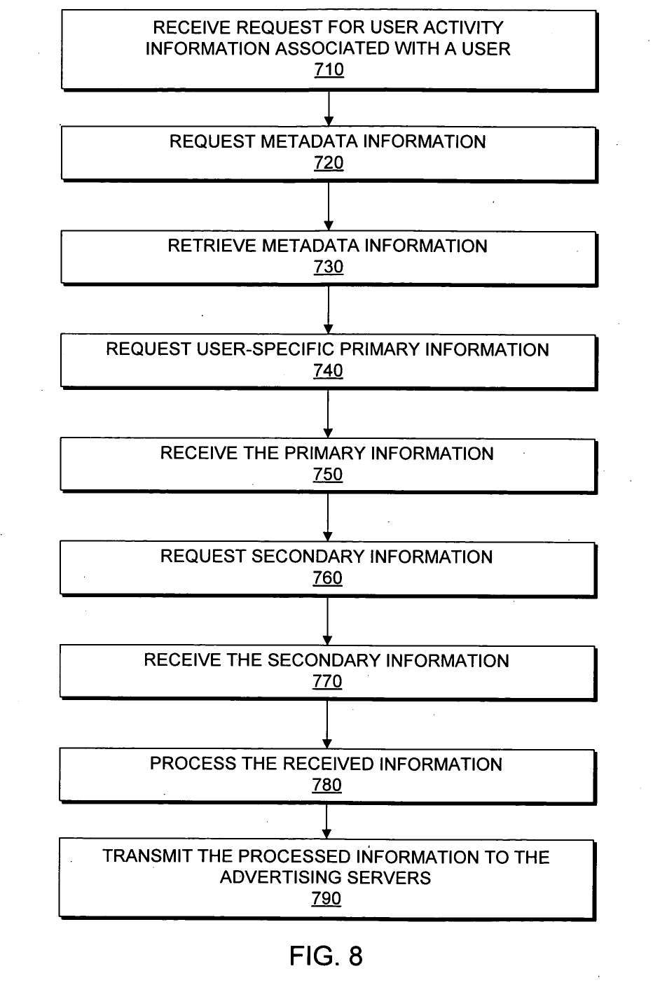

FIG. 8 is a flow diagram illustrating a method to retrieve optimized activity information, according to one embodiment of the invention. As shown in FIG. 8, at processing block 710, a request to retrieve user activity information related to a user is received from advertising servers 104.

At processing block 720, schema information related to the user and stored within the schema module 220 is requested. At processing block 730, schema information is retrieved from the schema module 220.

At processing block 740, user-specific primary information is requested from the activity storage module 230. At processing block 750, the retrieved primary property information is received from the activity storage module 230.

At processing block 760, secondary information is requested from the catalog storage module 240. At processing block 770, the retrieved secondary property information is received from the catalog storage module 240.

At processing block 780, the received primary information and secondary information associated with the requested user activity is processed and further transmitted, at processing block 790, to the advertising servers 104.

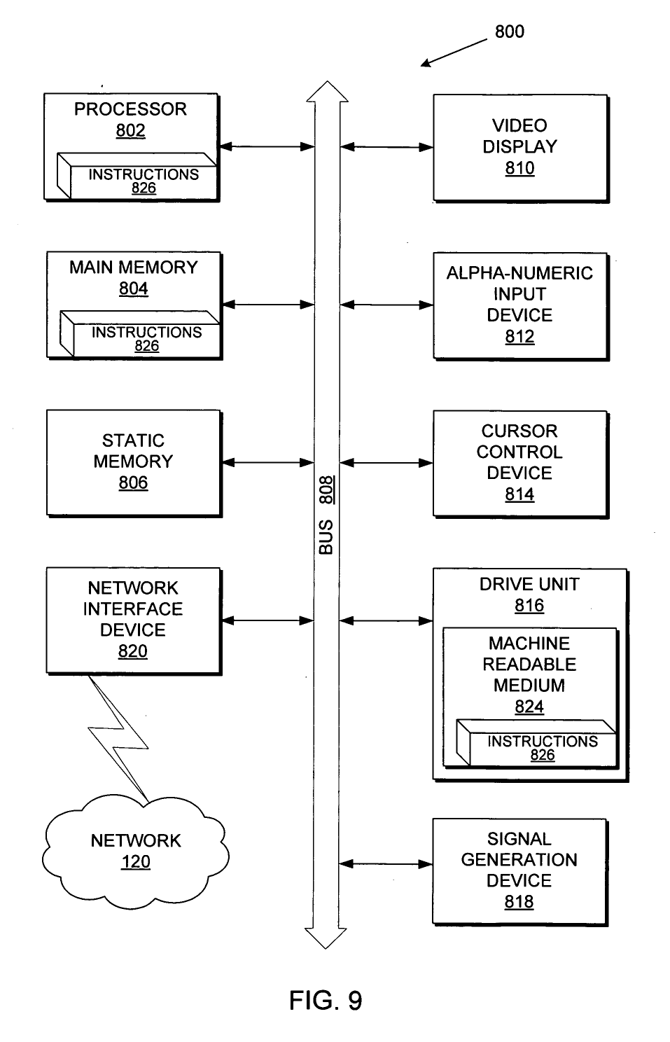

FIG. 9 shows a diagrammatic representation of a machine in the exemplary form of a computer system 800 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 800 includes a processor 802, a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a cursor control device 814 (e.g., a mouse), a disk drive unit 816, a signal generation device 818 (e.g., a speaker), and a network interface device 820.

The disk drive unit 816 includes a machine-readable medium 824 on which is stored a set of instructions (i.e., software) 826 embodying any one, or all, of the methodologies described above. The software 826 is also shown to reside, completely or at least partially, within the main memory 804 and/or within the processor 802. The software 826 may further be transmitted or received via the network interface device 820.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
receiving activity information related to an activity performed by a user over a network;
processing said activity information based on associated schema information to extract primary property information related to said user and containing an activity identification parameter related to said activity, and further to extract secondary property information related to additional aspects of said activity; and
transmitting said primary property information and said secondary property information to respective storage modules for subsequent storage.

2. The method according to claim 1, wherein said processing further comprises:
retrieving a data model within said schema information, said data model to define an activity class associated with said activity performed by said user based on a set of activity parameters.

3. The method according to claim 2, wherein said transmitting further comprises:
storing said primary property information and said secondary property information into said respective storage modules.

4. The method according to claim 1, wherein said transmitting further comprises:
storing said primary property information within an activity storage module of said respective storage modules;
discarding said secondary property information if already stored within a catalog storage module of said respective storage modules; and
updating a count associated with said secondary property information to show an increase in occurrence of said activity related to said secondary property information.

5. The method according to claim 1, wherein said transmitting further comprises:
storing said primary property information within an activity storage module of said respective storage modules; and
storing said secondary property information within a catalog storage module of said respective storage modules, if said secondary property information has changed from a previously stored version of said information.

6. The method according to claim 1, further comprising:
receiving a request for stored activity information related to said user;
retrieving said schema information;
retrieving said primary property information and said secondary property information from said respective storage modules;
processing said primary property information and said secondary property information based on said data model within said schema information to assemble said stored activity information; and
transmitting said stored activity information in response to said request.

7. A system comprising:
a plurality of storage modules to store processed activity information related to an activity performed by a user over a network; and
a processing engine coupled to said plurality of storage modules to receive and process said activity information based on associated schema information stored within a schema module coupled to said processing engine to extract primary property information related to said user and containing an activity identification parameter related to said activity, and further to extract secondary property information related to additional aspects of said activity, and to transmit said primary property information and said secondary property information to respective storage modules for subsequent storage.

8. The system according to claim 7, wherein said processing engine further retrieves a data model within said schema information, said data model to define an activity class associated with said activity performed by said user based on a set of activity parameters.

9. The system according to claim 8, wherein said processing engine further stores said primary property information and said secondary property information into said respective storage modules.

10. The system according to claim 7, wherein said processing engine further stores said primary property information within an activity storage module of said respective storage modules, discards said secondary property information if already stored within a catalog storage module of said respective storage modules, and updates a count associated with said secondary property information to show an increase in occurrence of said activity related to said secondary property information.

11. The system according to claim 7, wherein said processing engine further stores said primary property information within an activity storage module of said respective storage modules, and stores said secondary property information within a catalog storage module of said respective storage modules, if said secondary property information has changed from a previously stored version of said information.

12. The system according to claim 7, wherein said processing engine further receives a request for stored activity information related to said user, retrieves said schema information from said schema module, retrieves said primary property information and said secondary property information from said respective storage modules, processes said primary property information and said secondary property information based on said data model within said schema information to assemble said stored activity information, and transmits said stored activity information in response to said request.

13. A computer readable medium containing executable instructions, which, when executed in a processing system, cause said processing system to perform a method comprising:
receiving activity information related to an activity performed by a user over a network;
processing said activity information based on associated schema information to extract primary property information related to said user and containing an activity identification parameter related to said activity, and further to extract secondary property information related to additional aspects of said activity; and
transmitting said primary property information and said secondary property information to respective storage modules for subsequent storage.

14. The computer readable medium according to claim 13, wherein said processing further comprises:
retrieving a data model within said schema information, said data model to define an activity class associated with said activity performed by said user based on a set of activity parameters.

15. The computer readable medium according to claim 14, wherein said transmitting further comprises:
storing said primary property information and said secondary property information into said respective storage modules.

16. The computer readable medium according to claim 13, wherein said transmitting further comprises:
storing said primary property information within an activity storage module of said respective storage modules;
discarding said secondary property information if already stored within a catalog storage module of said respective storage modules; and
updating a count associated with said secondary property information to show an increase in occurrence of said activity related to said secondary property information.

17. The computer readable medium according to claim 13, wherein said transmitting further comprises:
storing said primary property information within an activity storage module of said respective storage modules; and
storing said secondary property information within a catalog storage module of said respective storage modules, if said secondary property information has changed from a previously stored version of said information.

18. The computer readable medium according to claim 13, wherein said method further comprises:
receiving a request for stored activity information related to said user;
retrieving said schema information;
retrieving said primary property information and said secondary property information from said respective storage modules;
processing said primary property information and said secondary property information based on said data model within said schema information to assemble said stored activity information; and
transmitting said stored activity information in response to said request.

19. A system comprising:
means for receiving activity information related to an activity performed by a user over a network;
means for processing said activity information based on associated schema information to extract primary property information related to said user and containing an activity identification parameter related to said activity, and further to extract secondary property information related to additional aspects of said activity; and
means for transmitting said primary property information and said secondary property information to respective storage modules for subsequent storage.

20. The system according to claim 19, further comprising:
means for retrieving a data model within said schema information, said data model to define an activity class associated with said activity performed by said user based on a set of activity parameters.

21. The system according to claim 19, further comprising:
means for storing said primary property information within an activity storage module of said respective storage modules;
means for discarding said secondary property information if already stored within a catalog storage module of said respective storage modules; and
means for updating a count associated with said secondary property information to show an increase in occurrence of said activity related to said secondary property information.

22. The system according to claim 19, further comprising:
means for storing said primary property information within an activity storage module of said respective storage modules; and
means for storing said secondary property information within a catalog storage module of said respective storage modules, if said secondary property information has changed from a previously stored version of said information.

23. The system according to claim 19, further comprising:
means for receiving a request for stored activity information related to said user;
means for retrieving said schema information;
means for retrieving said primary property information and said secondary property information from said respective storage modules;
means for processing said primary property information and said secondary property information based on said data model within said schema information to assemble said stored activity information; and
means for transmitting said stored activity information in response to said request.
